(19) United States
(12) Patent Application Publication
(10) Pub. No.: US 2026/0178044 A1
(43) Pub. Date: Jun. 25, 2026

(54) ROBOT CONTROL APPARATUS AND METHOD THEREOF

(71) Applicants: Hyundai Motor Company, Seoul (KR); Kia Corporation, Seoul (KR)

(72) Inventor: Gi Yong Park, Hwaseong-si (KR)

(21) Appl. No.: 19/213,724

(22) Filed: May 20, 2025

(30) Foreign Application Priority Data
Dec. 19, 2024 (KR) 10-2024-0191699

(51) Int. Cl. G05D 1/646

(52) U.S. Cl. CPC G05D 1/646

(57) ABSTRACT

In an embodiment a control method includes determining a target region on a map including a region of interest to which a robot is movable, determining a driving path of the robot based on a comparison between an entry score determined at a time point for the robot to move to the target region and a predetermined reference score and performing control of the robot based on the driving path.

### CROSS-REFERENCE TO RELATED APPLICATIONS

This application claims the benefit of priority to Korean Patent Application No. 10-2024-0191699, filed in the Korean Intellectual Property Office on Dec. 19, 2024, the entire contents of which are incorporated herein by reference.

### TECHNICAL FIELD

The present disclosure relates to a robot control apparatus and a method thereof, and more particularly, relates to technologies for controlling a robot based on driving data of the robot in a driving region on a one-way path.

### BACKGROUND

A technology associated with autonomous driving of a robot has been developed to help the robot to drive in various environments. Particularly, there is a technology for setting a path where the robot is drivable using map data and efficiently managing a driving direction and the path. Map data of the robot was used for specific purposes, such as precise improvement or cleaning, in an existing technology. However, there is a lack of a data utilization method necessary to implement one-way autonomous driving in a narrow space or a specialized driving function in which user requirements are reflected.

For example, an existing map generation technology does not support efficient and safe driving in a space constraint situation. There is no function of reflecting driving direction information of the robot in map data to provide an optimized path. Because the existing technology is focused on a specific purpose (e.g., cleaning or the like), it does not provide various reliable driving services in which user requirements are reflected.

As the environment in which the robot is used is gradually complicated and varies, there is a desire for a technology capable of efficiently operating in a narrow space or an environment in which one-way autonomous driving is required. Illustratively, it is difficult for the robot to perform efficient driving in an existing scheme on a narrow corridor or a road where it is possible to perform only one-way driving. Furthermore, there is a desire for a technical solution capable of providing a trustable driving function in a specific environment depending to user requirements.

To address such problems, there is a desire to develop a technology for providing an optimal one-way autonomous driving function, using data generated while the robot is driving and sensing data.

### SUMMARY

Embodiments solve the above-mentioned problems occurring in the prior art while advantages achieved by the prior art may be maintained.

An embodiment of the present disclosure provides a robot control apparatus for determining a target region and determining a driving path of a robot based on comparison between an entry score and a reference score to overcome a limit of a manual path setting scheme and be efficient and safe in various environments to increase reliability and a method thereof.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, a robot control apparatus may include a memory storing a computer-executable instruction and a processor that accesses the memory and executes the instruction. The processor may determine a target region where a robot is movable in a predetermined direction, on a map including a region of interest where the robot is movable, may determine a driving path of the robot, based on comparison between an entry score determined at a time point necessary for the robot to move to the target region and a predetermined reference score, and may perform control of the robot based on the driving path.

In an embodiment, the processor may determine the target region on the map via coordinate information of the target region, based on receiving the coordinate information from a server, may receive a direction vector in which the robot is required to move in the target region based on the predetermined direction and the coordinate information from the server, and may receive the reference score from the server, based on receiving the direction vector. The target region may include a polygon region formed based on the coordinate information.

In an embodiment, the processor may receive a reference speed which is a speed allowable for the robot in the target region and a predetermined global path about movement of the robot in the region of interest from the server and may determine a path vector predicted according to movement of the robot in the target region, from the global path.

In an embodiment, the processor may determine a sub-path which is a movement path of the robot in the target region, based on the global path and the target region, may segment the sub-path into a predetermined length to obtain at least one unit path, may determine a unit vector of each of the at least one unit path, and may add each of the at least one unit vector to determine the path vector.

In an embodiment, the processor may determine a path included in the target region in the global path as the sub-path, may determine a first point which is an entry point of the sub-path in the target region and a second point which is an exit point of the sub-path, and may determine the path vector, via a direction vector of the first point and a direction vector of the second point, based on that the predetermined length is the same as a length of the sub-path.

In an embodiment, the processor may determine a first score, based on a similarity between the path vector and the direction vector, may determine a second score indicating density of the target region, based on the target region and a size of an object included in the target region, and may determine a third score, based on the reference speed and predicted speed information expected if the robot passes through the target region.

In an embodiment, the processor may determine an obstacle area occupied in the target region by the object, if the object is identified as a dynamic obstacle in the target region, and may determine the second score, based on a ratio between a reference area which is an area of the target region and the obstacle area.

In an embodiment, the processor may determine the entry score, based on the first score, the second score, and the third score, and may determine the global path as the driving path, based on that the entry score is less than the reference score.

In an embodiment, the processor may obtain a first weight, a second weight, and a third weight from a path prediction model trained to output a weight applied to the entry score, may apply the first weight to the first score, may apply the second weight to the second score, may apply the third weight to the third score, and may determine the entry score, based on the first to third scores to which the weights are applied.

In an embodiment, the processor may determine the target region as a region where the robot is unmovable, based on that the entry score is greater than or equal to the reference score, and may redetermine a driving path of the robot, based on a region except for the target region in the region of interest.

According to another embodiment of the present disclosure, a robot control method may include determining a target region where a robot is movable in a predetermined direction, on a map including a region of interest where the robot is movable, determining a driving path of the robot, based on comparison between an entry score determined at a time point necessary for the robot to move to the target region and a predetermined reference score, and performing control of the robot based on the driving path.

In an embodiment, the performing of the control of the robot may include determining the target region on the map via coordinate information of the target region, based on receiving the coordinate information from a server, receiving a direction vector in which the robot is required to move in the target region based on the predetermined direction and the coordinate information from the server, and receiving the reference score from the server, based on receiving the direction vector. The target region may include a polygon region formed based on the coordinate information.

In an embodiment, the performing of the control of the robot may include receiving a reference speed which is a speed allowable for the robot in the target region and a predetermined global path about movement of the robot in the region of interest from the server and determining a path vector predicted according to movement of the robot in the target region, from the global path.

In an embodiment, the performing of the control of the robot may include determining a sub-path which is a movement path of the robot in the target region, based on the global path and the target region, segmenting the sub-path into a predetermined length to obtain at least one unit path, determining a unit vector of each of the at least one unit path, and adding each of the at least one unit vector to determine the path vector.

In an embodiment, the performing of the control of the robot may include determining a path included in the target region in the global path as the sub-path, determining a first point which is an entry point of the sub-path in the target region and a second point which is an exit point of the sub-path, and determining the path vector, via a direction vector of the first point and a direction vector of the second point, based on that the predetermined length is the same as a length of the sub-path.

In an embodiment, the performing of the control of the robot may include determining a first score, based on a similarity between the path vector and the direction vector, determining a second score indicating density of the target region, based on the target region and a size of an object included in the target region, and determining a third score, based on the reference speed and predicted speed information expected if the robot passes through the target region.

In an embodiment, the performing of the control of the robot may include determining an obstacle area occupied in the target region by the object, if the object is identified as a dynamic obstacle in the target region, and determining the second score, based on a ratio between a reference area which is an area of the target region and the obstacle area.

In an embodiment, the performing of the control of the robot may include determining the entry score, based on the first score, the second score, and the third score, and determining the global path as the driving path, based on that the entry score is less than the reference score.

In an embodiment, the performing of the control of the robot may include obtaining a first weight, a second weight, and a third weight from a path prediction model trained to output a weight applied to the entry score, applying the first weight to the first score, applying the second weight to the second score, applying the third weight to the third score, and determining the entry score, based on the first to third scores to which the weights are applied.

In an embodiment, the performing of the control of the robot may include determining the target region as a region where the robot is unmovable, based on that the entry score is greater than or equal to the reference score, and redetermining a driving path of the robot, based on a region except for the target region in the region of interest.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a block diagram of a robot control apparatus according to an embodiment of the present disclosure;

FIG. 2 is a flowchart for describing a robot control method according to an embodiment of the present disclosure;

FIG. 3 is a drawing illustrating a block diagram of a configuration included in a processor, in a robot control apparatus according to an embodiment of the present disclosure;

FIG. 4 is a drawing illustrating an example of a target region;

FIG. 5 is a drawing for describing a method for setting a driving path of a robot, in a robot control apparatus according to an embodiment of the present disclosure;

FIG. 6 is a drawing illustrating an example of a path vector and a direction vector, in a robot control apparatus according to an embodiment of the present disclosure;

FIG. 7 is a flowchart for describing a robot control method, in a robot control apparatus according to an embodiment of the present disclosure; and

FIG. 8 is a drawing illustrating a computing system associated with a robot control apparatus or a robot control method according to an embodiment of the present disclosure.

With regard to description of drawings, the same or similar components will be marked by the same or similar reference signs.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure. Particularly, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, the terms, such as “first”, “second”, “1st”, “2nd”, or the like used in the present disclosure may be used to refer to various components regardless of the order and/or the priority and to distinguish one component from another component, but do not limit the components. For example, “a first user device” and “a second user device” may indicate different user devices regardless of the order or priority thereof. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It will be understood that when a component (e.g., a first component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to the situation, the expression “configured to” used in the present disclosure may be used exchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in the present disclosure are used to describe specified embodiments and are not intended to limit the scope of another embodiment. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the present disclosure, they may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

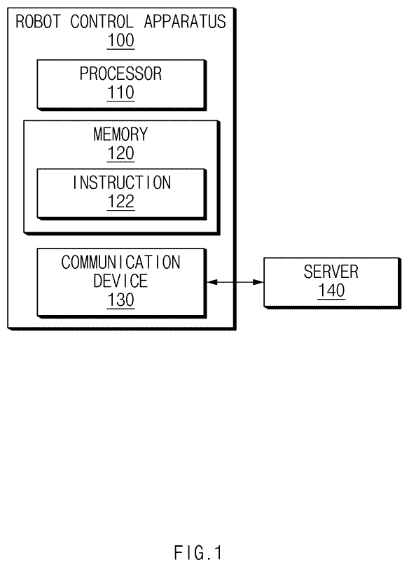

Hereinafter, embodiments of the present disclosure will be described in detail with reference to FIGS. 1 to 8.

FIG. 1 is a drawing illustrating a block diagram of a robot control apparatus according to an embodiment of the present disclosure.

A robot control apparatus 100 according to an embodiment may include a processor 110, a memory 120 including an instruction 122, and a communication device 130.

The robot control apparatus 100 may indicate a device which determines a driving path of a robot.

The robot control apparatus 100 may perform driving path determination based on map data and a score to set and control an autonomous driving path of the robot. The robot control apparatus 100 may identify a region of interest and a target region from map data and may set a path such that the robot is able to move in a specific direction. The robot control apparatus 100 may compare an entry score with a reference score at an entry time point of the target region to dynamically determine a driving path of the robot.

The robot control apparatus 100 may receive coordinate information and a direction vector of the target region from a server 140, may set a sub-path in a global path based on the coordinate information and the direction vector, and may segment a unit path to generate a path vector. Furthermore, the robot control apparatus 100 may calculate a score based on a similarity between the path vector and the direction vector, obstacle density in the target region, a reference speed, and a predicted speed. The robot control apparatus 100 may determine whether the robot is movable or may set an alternative path, via the entry score obtained by applying a weight to each of scores.

Particularly, if there is a dynamic obstacle in the target region, the robot control apparatus 100 may calculate a ratio between an obstacle area occupied by the obstacle and a reference area to calculate density. As a result, the robot control apparatus 100 may facilitate intelligent driving path generation and control based on environmental data and real-time information and may support stable and efficient robot operation in various environments.

The processor 110 may execute software and may control at least one other component (e.g., a hardware or software component) connected with the processor 110. In addition, the processor 110 may perform a variety of data processing or computation. For example, the processor 110 may store the region of interest, the target region, the entry score, the reference score, or the like in the memory 120.

For reference, the processor 110 may perform all operations performed by the robot control apparatus 100. Therefore, for convenience of description in the specification, the operation performed by the robot control apparatus 100 is mainly described as an operation performed by the processor 110. Furthermore, for convenience of description in the specification, the processor 110 is mainly described as, but not limited to, one processor. For example, the robot control apparatus 100 may include processors. Each of the processors may perform all operations associated with a robot control operation.

The memory 120 may store temporarily and/or permanently store various pieces of data and/or information required to perform the robot control operation. For example, the memory 120 may store the region of interest, the target region, the entry score, the reference score, or the like.

The communication device 130 may assist in performing communication between the robot control apparatus 100 and the server 140. For example, the communication device 130 may include one or more components for performing communication between the robot control apparatus 100 and the server 140. For example, the communication device 130 may include a short range wireless communication unit, a microphone, or the like. At this time, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

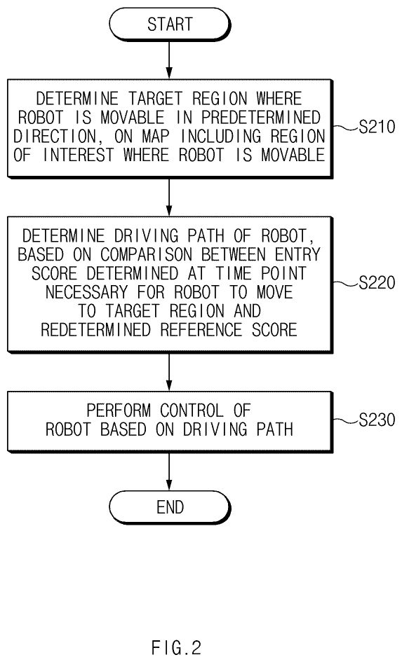

FIG. 2 is a flowchart for describing a robot control method according to an embodiment of the present disclosure.

In S210, a processor (e.g., a processor 110 of FIG. 1) according to an embodiment may determine a target region where a robot is movable in a predetermined direction, on a map including a region of interest where the robot is movable.

For example, the region of interest may refer to a specific portion of the entire map where the robot is movable and may refer to a region selected to analyze or use data associated with a possibility that the robot will move. The region of interest may be a region including environmental data in supporting movement and operation of the robot, which may provide a range which is initial criteria for evaluating a possibility of movement or setting a path on a map.

The target region may refer to a specific region where the robot is movable in only one way in the region of interest. The target region may be a zone where the robot should set a driving path or should determine a driving direction depending on predetermined directionality, which may be set to increase driving efficiency and safety of the robot. The target region may be defined in the form of a polygon and may be embodied based on additional driving data, such as a direction vector and speed information.

In S220, the processor may determine a driving path of the robot, based on comparison between an entry score determined at a time point necessary for the robot to move to the target region and a predetermined reference score.

The time point necessary to move to the target region may refer to a time when there occurs the necessity for the robot to perform a specific task or move along a specific path. The above-mentioned time point may be defined as a time point when the robot should access the target region from a current location or should start one-way driving. The above-mentioned time point may be dynamically determined according to a driving situation, an environmental condition, and a task requirement of the robot.

The entry score may refer to a quantitative index calculated to evaluation whether the robot is suitable to enter the target region. The entry score may be calculated based on various elements, such as a movement path of the robot, a speed of the robot, obstacle density, and a similarity with a driving direction in the target region, and may be used to determine a possibility of safely and efficiently entering the target region.

The reference score may be a threshold for determining whether the robot is able to enter the target region, which may refer to a preset quantitative index. The reference score may be set by reflecting driving stability and an environmental requirement of the robot and may be compared with the entry score to determine whether it is possible for the robot to enter the target region.

The driving path may refer to a path along which the robot should move and may refer to the overall movement plan including access to the target region and movement before and after movement to the target region. The driving path may be dynamically set based on the result of comparing the entry score with the reference score and may be designed such that the robot is able to safely and efficiently reach a destination.

In S230, the processor may perform control of the robot based on the driving path.

The processor may control a speed of the robot depending on the driving path of the robot. For example, if the robot detects a dynamic obstacle in the target region or should pass through a zone with high obstacle density, the processor may compare a reference speed with an estimated speed to dynamically reduce the speed of the robot. On the other hand, the processor may increase the speed of the robot in a zone with low density or a zone without an obstacle on a path, thus optimizing a task time.

The processor may dynamically control a movement direction of the robot, based on the driving path and the direction vector set in the target region. Particularly, in a region where one-way driving is required, the processor may adjust a steering angle such that the robot moves along a similar path to the direction vector and may prevent an unnecessary change of direction in the target region. As a result, if the robot moves in a narrow corridor or a complex environment, the processor may reduce path departure of the robot or risk of a collision between the robot and an object.

If the robot detects a dynamic or static obstacle on the driving path, the processor may generate an avoidance path in real time to correct the driving path. For example, the processor may analyze an obstacle area in the target region and density of the path and may reset the sub-path based on the analyzed result. As a result, the robot may maintain a one-way characteristic of the target region, while avoiding the obstacle, and may safely move.

If it is determined that it is unable for the robot to enter the target region, as a result of the comparison between the entry score and the reference score, the processor may dynamically calculate a new driving path. In this process, the processor may search for another target region in the region of interest and may generate a new sub-path to control driving of the robot. Path re-planning may assist the robot to reach a goal without stopping a task, if an environmental change or an unexpected obstacle occurs.

The processor may control the robot to perform a specific task (e.g., goods transportation, cleaning, or data collection) while moving along the driving path. For example, the processor may accurately check a task performance position, if the robot reaches the target region, and may adjust a movement speed, a direction, a stop point, or the like to perform a set task.

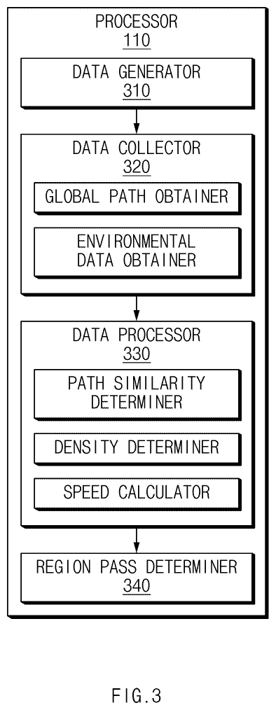

FIG. 3 is a drawing illustrating a block diagram of a configuration included in a processor, in a robot control apparatus according to an embodiment of the present disclosure.

FIG. 3 is a block diagram illustrating a main configuration of a processor 110 and operation flow thereof according to an embodiment of the present disclosure. The processor 110 may perform a function of generating, collecting, processing, and determining data required in a process of setting and controlling a driving path of a robot, based on one-way traffic and/or map data including a region where the one-way traffic is required.

A data generator 310 may generate region data for the region where the one-way traffic is required. For example, the data generator 310 may identify a target region based on a region of interest from the map data and may extract and generate region data for a region where a robot is movable in only one way. The data generator 310 may transmit initial data necessary to determine a driving path of the robot to a data collector 320.

The data collector 320 may collect various pieces of data associated with driving of the robot. For example, the data collector 320 may include a global path obtainer and an environmental data obtainer. In detail, the data collector 320 may obtain the entire path (i.e., a global path) along which the robot is movable and may collect basic data for setting optimal driving directionality of the robot. The data collector 320 may collect environmental data obtained via a sensor and the other data sources while the robot is driving. The collected environmental data may include obstacle location, density information in a region, speed information, or the like. The data collector 320 may transmit the global path and the environmental data to a data processor 330.

The data processor 330 may process data for determining a possibility that the robot will enter a region based on the collected data. For example, the data processor 330 may include a path similarity determiner, a density determiner, and a speed calculator. In detail, the data processor 330 may calculate a similarity between directionality of the global path and a one-way driving direction vector (i.e., a direction vector) of the target region. As a result, the data processor 330 may determine whether the driving direction of the robot is similar to a set direction of the target region. The data processor 330 may compare an obstacle area in the target region with a reference area to determine density. The data processor 330 may compare a reference speed in the target region with an estimated driving speed of the robot to evaluate a speed difference. The data processor 330 may generate and transmit quantitative data, such as a path similarity, density, and a speed, to a region pass determiner 340.

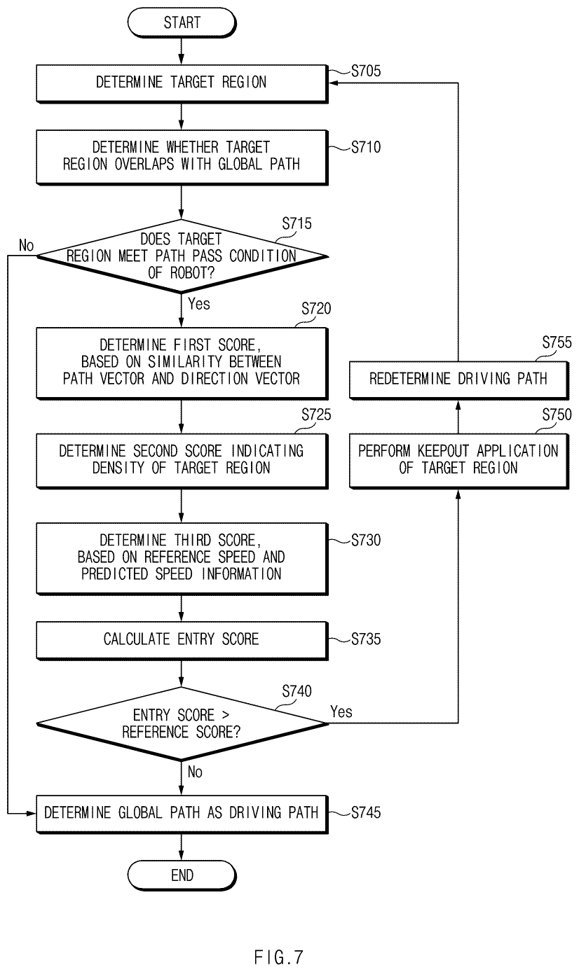

The region pass determiner 340 may determine whether it is possible for the robot to pass through the target region, based on the processed data. The region pass determiner 340 may calculate an entry score via a formula based on the processed data (i.e., the path similarity, the density, or the speed). The formula will be described in detail below in FIG. 7. The region pass determiner 340 may compare the calculated entry score with a predetermined reference score to determine whether the robot is able to enter the target region.

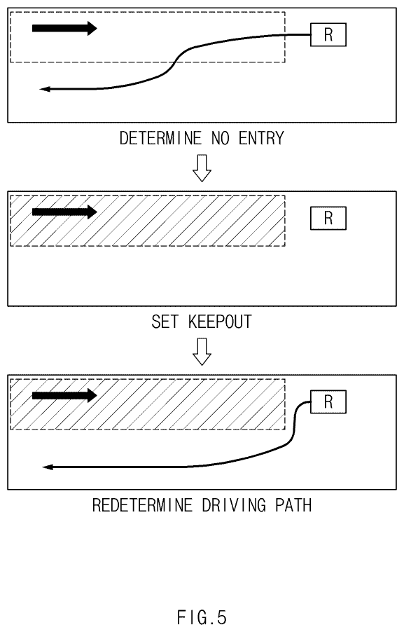

If the entry score is greater than or equal to the reference score, the region pass determiner 340 may redetermine a driving path of the robot. Illustratively, the region pass determiner 340 may determine the target region as a region where it is impossible for the robot to move, based on that the entry score is greater than or equal to the reference score. The region pass determiner 340 may redetermine the driving path of the robot, based on a region except for the target region in the region of interest. A description of the region where it is impossible for the robot to move will be given below in FIG. 5.

If the entry score is less than the reference score, the region pass determiner 340 may set the driving path of the robot to the global path. A detailed description associated with it will be given below in FIG. 7.

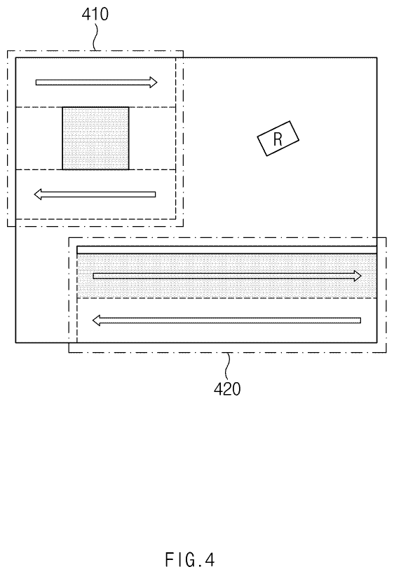

FIG. 4 is a drawing illustrating an example of a target region.

FIG. 4 is a drawing illustrating structures of a region of interest and a target region and pieces of information of the regions. The entire map illustrated in FIG. 4 may be defined as a region of interest where a robot is movable. The region of interest may include a first target region 410 and a second target region 420.

The region of interest may be a specific region where the robot is movable in the entire map and may be set to set a driving path of the robot and determine whether the robot drives. The region of interest may be generated based on information received from a server (e.g., a server 140 of FIG. 1). The target region may refer to a specific region where the robot should perform one-way driving in the region of interest.

Illustratively, the first target region 410 may have a structure shown in FIG. 4 and may be a region where the robot should rotate and move in one way. Illustratively, the second target region 420 may be a region configured in the form of a straight line, which may be a region set such that the robot drives in only one way.

The target region may include a polygon region formed based on coordinate information. In detail, the information of the target region may include coordinate information and a direction vector.

The coordinate information may refer to coordinate information for each point of a polygon forming a boundary line of the target region. A processor may generate an accurate location and shape of the target region via the coordinate information. The direction vector may be a vector generated in the target region on the basis of a current map coordinate system. The direction vector indicates a direction in which the robot is able to drive in one way in the region.

For example, the first target region 410 may include direction vectors in which the robot should drive while rotating and the second target region 420 may include direction vectors for straight movement. The target region may include a reference score. The reference score may be a value previously calculated (or predetermined) by the server, which may be used to evaluate whether it is possible for the robot to enter the target region.

FIG. 5 is a drawing for describing a method for setting a driving path of a robot, in a robot control apparatus according to an embodiment of the present disclosure.

FIG. 5 is a drawing illustrating a process of setting a target region to a no-entry region (i.e., keep-out) and redetermining a new driving path, if it is determined that it is impossible for a robot to enter the target region, in a processor (e.g., a processor 110 of FIG. 1) according to an embodiment of the present disclosure.

The processor may calculate an entry score of the target region and may determine the target region as an impossible entry region, via comparison between the entry score and a predetermined reference score. For example, if the entry score is greater than or equal to the reference score, the processor may determine the target region as being in an impossible entry state. Illustratively, the entry score may be calculated as a value larger than the reference score, if obstacle density of the target region is high or a path similarity with a direction vector is low.

The processor may set the target region determined that it is impossible to be entered to a no-entry region. For example, the no-entry region may be a region set to allow the robot not to be entered in the target region, may be a region which is not considered if redetermining a driving path of the robot, and may be the entire target region. The target region is visually separated from a region of interest.

The processor may generate a new driving path based on the remaining region except for the target region set to the no-entry region in the region of interest. The new driving path may be calculated such that the robot safely and efficiently reaches a destination and may be a path optimized while avoiding an obstacle. For example, if an existing path is determined as being in an impossible entry state, the robot may move along an alternative path for bypassing the target region.

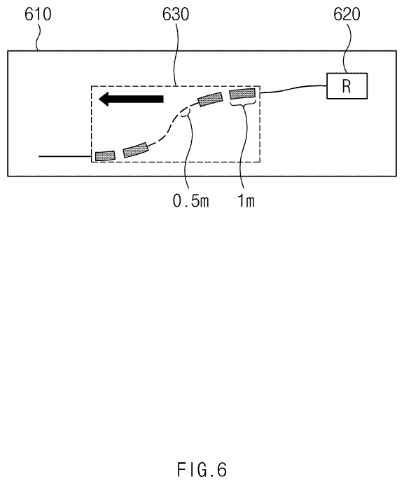

FIG. 6 is a drawing illustrating an example of a path vector and a direction vector, in a robot control apparatus according to an embodiment of the present disclosure.

FIG. 6 is a drawing illustrating a process of setting a sub-path in a target region 630 and determining a path vector in a processor (e.g., a processor 110 of FIG. 1) according to an embodiment of the present disclosure.

The processor may set a movement path of a robot 620 in the target region 630 and may determine a path vector based on the movement path. The processor may determine a sub-path for the robot 620 to move in the target region 630, on the basis of a global path and the target region 630.

The processor may receive a reference speed, which is a speed allowable for the robot 620 in the target region 630, and a predetermined global path about movement of the robot 620 in a region of interest 610 from a server (e.g., a server 140 of FIG. 1).

The sub-path may be set on the basis of a shape and a direction vector of the target region 630 (e.g., an arrow in the target region 630 in FIG. 6) and may be calculated such that driving of the robot 620 is efficiently and safely performed.

The processor may determine a path vector predicted according to movement of the robot 620 in the target region 630, from the global path. In detail, the processor may determine a sub-path which is a movement path of the robot 620 in the target region 630, based on the global path and the target region 630. The processor may segment the sub-path into a predetermined length to obtain at least one unit path. The processor may determine a unit vector of each of the at least one unit path and may add each of the at least one unit vector to determine a path vector.

The processor may segment the sub-path into predetermined lengths to obtain several unit paths. The processor may adjust the length of the unit path depending on the speed of the robot 620. Illustratively, the processor may set the length of the unit path to 0.5 m in a slow speed interval and may set the length of the unit path to 1 m in a general speed interval.

The processor may obtain a unit vector between a starting point and an end point of each unit path. The unit vector may represent directionality of the sub-path and a movement trajectory of the robot 620. The path vector may be described by Equation 1 below.

$$\vec{v} = \frac{1}{N} {\sum }_{j = 1}^{N} ( \vec{{p}_{j + 1}} - \vec{{p}_{j}} ) \qquad [ Equation 1 ]$$

Herein, \vec{v} may refer to the path vector, N may refer to the number of unit vectors, and \vec{pⱼ} may refer to the unit vector.

The processor may determine a path included in the target region in the global path as the sub-path and may determine a first point which is an entry point of the sub-path in the target region and a second point which is an exit point of the sub-path. The processor may determine the path vector, via a direction vector of the first point and a direction vector of the second point, based on that the predetermined length is the same as the length of the sub-path. In other words, the processor may fail to generate a unit vector, based on that the predetermined length is the same as the length of the sub-path, and may determine a vector of the sub-path (e.g., a vector based on the direction vector of the first point and the direction vector of the second point) as the path vector.

FIG. 7 is a flowchart for describing a robot control method, in a robot control apparatus according to an embodiment of the present disclosure.

FIG. 7 is a flowchart illustrating a method for determining a driving path of a robot in a processor (e.g., a processor 110 of FIG. 1) according to an embodiment of the present disclosure. The processor may analyze information of a target region, may determine whether it is possible for a robot to enter the target region, and may redetermine a driving path if necessary.

In S705, the processor may determine a target region where the robot is movable in one way in a region of interest. The target region may be defined based on map data and a direction vector.

The processor may determine the target region in a map (or the region of interest) via coordinate information, based on receiving coordinate information of the target region from a server. The processor may receive a direction vector in which the robot is requested to move in the target region based on a predetermined direction and the coordinate information from the server. The processor may receive a reference score from the server, based on receiving the direction vector.

In S710, the processor may determine whether the target region overlaps with a global path. The processor may check whether the target region is associated with a movement path of the robot and may perform a subsequent operation.

In S715, the processor may determine whether the target region meets a path pass condition of the robot. If the robot does not pass through the target region, the processor may determine the global path as a driving path.

In S720, the processor may determine a first score, based on a similarity between the path vector and the direction vector. The processor may calculate a similarity between the direction vector of the target region and a vector (i.e., the path vector) based on predicted movement of the robot in the target region. The similarity may be information for quantitatively evaluating how much the driving path of the robot is identical to a one-way characteristic of the target region.

The first score may be described by Equation 2 below.

$$cos ( θ ) = \frac{‖ \vec{{v}_{1}} ‖ ‖ \vec{{v}_{2}} ‖}{\vec{{v}_{1}} \cdot \vec{{v}_{2}}} \qquad [ Equation 2 ]$$

Herein, cos(θ) may refer to the first score, \vec{v₁} may refer to the direction vector, and \vec{v₂} may refer to the path vector.

In S725, the processor may determine a second score indicating density of the target region, based on the target region and a size of an object included in the target region. The density may be determined by comparing an area of an obstacle with a reference area and may be a main element for evaluating a possibility of entering the target region. If the object is identified as a dynamic obstacle in the target region, the processor may determine an obstacle area occupied in the target region by the object and may determine the second score, based on a ratio between a reference area, which is an area of the target region, and the obstacle area.

The second score may be described by Equation 3 below.

$$ρ = \frac{{A}_{region}}{{N}_{obstacles}} \qquad [ Equation 3 ]$$

Herein, ρ may refer to the second score, N_{obstacles} may refer to the obstacle area, and A_{region} may refer to the reference area.

The dynamic obstacle refers to an object which moves in the target region. This is an element capable of interfering with a driving path of the robot, which has a characteristic in which the location varies over time. The obstacle area refers to an area occupied in the target region by the dynamic obstacle. The reference area refers to the entire area of the target region. The reference area is calculated based on each point coordinates of the target region defined in the form of a polygon and is used to determine density of the target region via the ratio with the obstacle area.

In S730, the processor may determine a third score, based on a reference speed (or a speed limit) and predicted speed information expected if the robot passes through the target region. As a result, the processor may evaluate whether the robot is able to maintain a safe and efficient speed if passing through the target region.

In S735, the processor may calculate an entry score. For example, the processor may calculate the entry score, based on a path similarity (i.e., the first score), density (i.e., the second score), and a speed ratio (i.e., the third score). The entry score is criteria for determining whether the robot is able to enter the target region.

The entry score may be described by Equation 4 below.

$$score = α \times cos ( θ ) + β \times ( 1 - ρ ) + γ ( 1 - \vert \frac{{v}_{robot} - {v}_{reference}}{{v}_{reference}} \vert ) \qquad [ Equation 4 ]$$

Herein, a may refer to the first weight, β may refer to the second weight, γ may refer to the third weight

$$( 1 - \vert \frac{{v}_{robot} - {v}_{reference}}{{v}_{reference}} \vert )$$

may refer to the third score, v_{robot} may refer to the predicted speed information of the robot, and v_{reference} may refer to the reference speed.

The processor may obtain a first weight, a second weight, and a third weight, from a path prediction model trained to output a weight applied to the entry score.

For example, the processor may train the path prediction model. The path prediction model may include a neural network. The neural network may include a plurality of layers. Each layer may include a plurality of nodes. The node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

Illustratively, the forward propagation computation in the path prediction model may indicate computation for propagating a node value based on input data, in a direction facing the output layer of the path prediction model from the input layer of the path prediction model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

The node value of the node may be determined based on applying the activation function to the sum (e.g., weighted sum) of weighted values received from previous nodes. The parameter of the neural network may illustratively include the above-mentioned connection weight. The parameter of the neural network may be updated to change in a direction in which an objective function value, which will be described below, is targeted (e.g., a direction in which a loss is minimized).

The trained path prediction model may indicate a model trained via machine learning and may be a machine learning model trained to output a training output (e.g., a first weight, a second weight, or a third weight) from a training input (e.g., environmental data). The machine learning model (e.g., the trained path prediction model) may be generated via machine learning. A learning algorithm may include, for example, but is not limited to, supervised learning, unsupervised learning, semi-supervised learning, or reinforcement learning.

The machine learning model may include a plurality of artificial neural network layers. In detail, the trained path prediction model may include a shared layer including at least one convolution operation and a plurality of classifier layers (e.g., task-specific layers) connected with the shared layer. An artificial neural network may be, but is not limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), or deep Q-networks, or any combination thereof.

In S740, the processor may determine whether the entry score is greater than a reference score. For example, in S745, the processor may determine the global path as a driving path, based on that the entry score is less than the reference score.

In S750, the processor may perform keep-out application of the target region. A detailed description associated with it may be the same as the contents described above in FIG. 5.

In S755, the processor may redetermine a driving path. For example, the processor may redetermine a new driving path with regard to a region of interest except for the target region which is kept out.

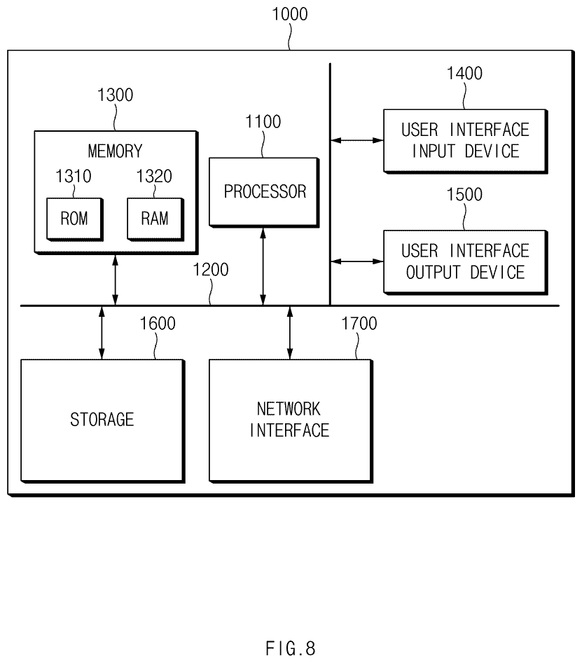

FIG. 8 is a drawing illustrating a computing system associated with a robot control apparatus or a robot control method according to an embodiment of the present disclosure.

Referring to FIG. 8, a computing system 1000 about the robot control apparatus or the robot control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it may be obviously to one skilled in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description will be given of effects of the robot control apparatus and the method thereof according to an embodiment of the present disclosure.

According to at least one of embodiments of the present disclosure, the robot control apparatus may determine a target region and may determine a driving path of a robot based on comparison between an entry score and a reference score, thus overcoming a limit of a manual path setting scheme and being efficient and safe in various environments to increase reliability.

In addition, various effects ascertained directly or indirectly through the present disclosure may be provided.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A control apparatus comprising:
a memory storing a computer-executable instruction; and
a processor configured to access the memory and execute the instruction, wherein the processor is configured to:
determine a target region on a map including a region of interest to which a robot is movable;
determine a driving path of the robot based on a comparison between an entry score determined at a time point for the robot to move to the target region and a predetermined reference score; and
perform control of the robot based on the driving path.

2. The control apparatus of claim 1, wherein the processor is configured to:
determine the target region on the map via coordinate information of the target region based on receiving the coordinate information from a server;
receive a direction vector in which the robot is able to move in the target region based on the predetermined direction and the coordinate information from the server; and
receive the reference score from the server based on receiving the direction vector,
wherein the target region includes a polygon region formed based on the coordinate information.

3. The control apparatus of claim 2, wherein the processor is configured to:
receive a reference speed for the robot in the target region and a predetermined global path about a movement of the robot in the region of interest from the server; and
determine a path vector predicted from the global path according to the movement of the robot in the target region.

4. The control apparatus of claim 3, wherein the processor is configured to:
determine a sub-path, which is a movement path of the robot in the target region, based on the global path and the target region;
segment the sub-path into a predetermined length to obtain at least one unit path;
determine a unit vector of each of the at least one unit path; and
add each of the at least one unit vector to determine the path vector.

5. The control apparatus of claim 4, wherein the processor is configured to:
determine a path included in the target region in the global path as the sub-path;
determine a first point, which is an entry point of the sub-path in the target region, and a second point, which is an exit point of the sub-path; and
determine the path vector, via a direction vector of the first point and a direction vector of the second point, based on the predetermined length being the same as a length of the sub-path.

6. The control apparatus of claim 3, wherein the processor is configured to:
determine a first score based on a similarity between the path vector and the direction vector;
determine a second score indicating a density of the target region based on the target region and a size of an object included in the target region; and
determine a third score based on the reference speed and predicted speed information expected based on the robot passing through the target region.

7. The control apparatus of claim 6, wherein the processor is configured to:
determine an obstacle area in the target region by the object based on the object being identified as a dynamic obstacle in the target region; and
determine the second score based on a ratio between a reference area, which is an area of the target region, and the obstacle area.

8. The control apparatus of claim 6, wherein the processor is configured to:
determine the entry score based on the first score, the second score, and the third score; and
determine the global path as the driving path based on the entry score being less than the reference score.

9. The control apparatus of claim 8, wherein the processor is configured to:
obtain a first weight, a second weight, and a third weight from a path prediction model trained to output a weight applied to the entry score;
apply the first weight to the first score;
apply the second weight to the second score;
apply the third weight to the third score; and
determine the entry score based on the weighted first to third scores.

10. The control apparatus of claim 8, wherein the processor is configured to:
determine the target region as a region in which the robot is unable to move based on the entry score being greater than or equal to the reference score; and
redetermine a driving path of the robot based on a region except for the target region in the region of interest.

11. A control method comprising:
determining a target region on a map including a region of interest to which a robot is movable;
determining a driving path of the robot based on a comparison between an entry score determined at a time point for the robot to move to the target region and a predetermined reference score; and
performing control of the robot based on the driving path.

12. The control method of claim 11, wherein performing the control of the robot includes:
determining the target region on the map via coordinate information of the target region based on receiving the coordinate information from a server;
receiving a direction vector in which the robot is able to move in the target region based on the predetermined direction and the coordinate information from the server; and
receiving the reference score from the server, based on receiving the direction vector,
wherein the target region includes a polygon region formed based on the coordinate information.

13. The control method of claim 12, wherein performing the control of the robot includes:
receiving a reference speed for the robot in the target region and a predetermined global path about a movement of the robot in the region of interest from the server; and
determining a path vector predicted from the global path according to the movement of the robot in the target region.

14. The control method of claim 13, wherein performing the control of the robot includes:
determining a sub-path, which is a movement path of the robot in the target region, based on the global path and the target region;
segmenting the sub-path into a predetermined length to obtain at least one unit path;
determining a unit vector of each of the at least one unit path; and
adding each of the at least one unit vector to determine the path vector.

15. The control method of claim 14, wherein performing the control of the robot includes:
determining a path included in the target region in the global path as the sub-path;
determining a first point, which is an entry point of the sub-path in the target region, and a second point, which is an exit point of the sub-path; and
determining the path vector via a direction vector of the first point and a direction vector of the second point based on the predetermined length being the same as a length of the sub-path.

16. The control method of claim 13, wherein performing the control of the robot includes:
determining a first score based on a similarity between the path vector and the direction vector;
determining a second score indicating a density of the target region based on the target region and a size of an object included in the target region; and
determining a third score based on the reference speed and predicted speed information expected based on the robot passing through the target region.

17. The control method of claim 16, wherein performing the control of the robot includes:
determining an obstacle area in the target region by the object based on the object being identified as a dynamic obstacle in the target region; and
determining the second score based on a ratio between a reference area, which is an area of the target region, and the obstacle area.

18. The control method of claim 16, wherein performing the control of the robot includes:
determining the entry score based on the first score, the second score, and the third score; and
determining the global path as the driving path based on the entry score being less than the reference score.

19. The control method of claim 18, wherein performing the control of the robot includes:
obtaining a first weight, a second weight, and a third weight from a path prediction model trained to output a weight applied to the entry score;
applying the first weight to the first score;
applying the second weight to the second score;
applying the third weight to the third score; and
determining the entry score, based on the first to third scores to which the weights are applied.

20. The control method of claim 18, wherein performing the control of the robot includes:
determining the target region as a region in which the robot is unable to move based on the entry score being greater than or equal to the reference score; and
redetermining a driving path of the robot based on a region except for the target region in the region of interest.
